(19) United States
(12) Patent Application Publication
(10) Pub. No.: US 2011/0260653 A1
(43) Pub. Date: Oct. 27, 2011

(54) STROBOSCOPE LIGHT FOR SUBWOOFERS AND LOW FREQUENCY SPEAKERS

(76) Inventor: Vytautas Janusonis, Vilnius (LT)

(21) Appl. No.: 13/141,778

(22) PCT Filed: Aug. 11, 2009
(86) PCT No.: PCT/LT09/00009

§ 371 Date: Jun. 23, 2011

(30) Foreign Application Priority Data
Dec. 23, 2008 (LT) 2008 102

(51) Int. Cl. H05B 37/00

(52) U.S. Cl. 315/312

(57) ABSTRACT

A system, which forms a special signal for a light source to illuminate a moving speaker area audio source, by creating a visual stroboscope effect. The moving speaker area is illuminated with specially modulated light source pulses, which are created according to incoming audio signal source. The system creates visual virtual speaker moving effect.

### TECHNICAL FIELD

Field of invention is related with sound system and its illumination with light, more detailed—with illumination effects, which are related and controlled by incoming audio signal.

### BACKGROUND ART

There are known few technical solutions, where illumination light is combined with audio signals to make various visual effects, such as light blinking according to audio signal peak values, different color light according to audio peak values in different frequency zones and etc.

There is also known a technical solution—G. Britain patent GB 2405218, published 2005, Feb. 23. There is used stroboscope effect and it is controlled by motor system with light-valve, which opens or closes light source lighting on a device block surface.

Another patent are made in United States (US 2004/0175014 A1). There are used a visual effects which are created using light emitting diodes light and concentrating it on speaker and environment near it. One or more light sources are connected to speaker diaphragm and effects are controlled from control station: using sound or in electronical way.

All before mentioned technical solutions have various lighting effects, but no one of them uses stroboscope effect lighting, where light (on/off) signals are controlled and changed using audio sound signal.

### SUMMARY OF INVENTION

Using such an invention it is possible to create effect, which is related on sound source signal transferred to special module, ant by this module special frequency signal will be created. This signal will be used to make a light effect on moving speaker membrane. It will create special type effect, which will appear because of the strobe phenomenon.

### BRIEF DESCRIPTION OF DRAWINGS

FIG. 1—stroboscope illumination effect module working diagram

FIG. 2—incoming signal from audio source (8), low frequency modulated signal for illumination output (6) visual image in time axis.

### DESCRIPTION OF EMBODIMENTS

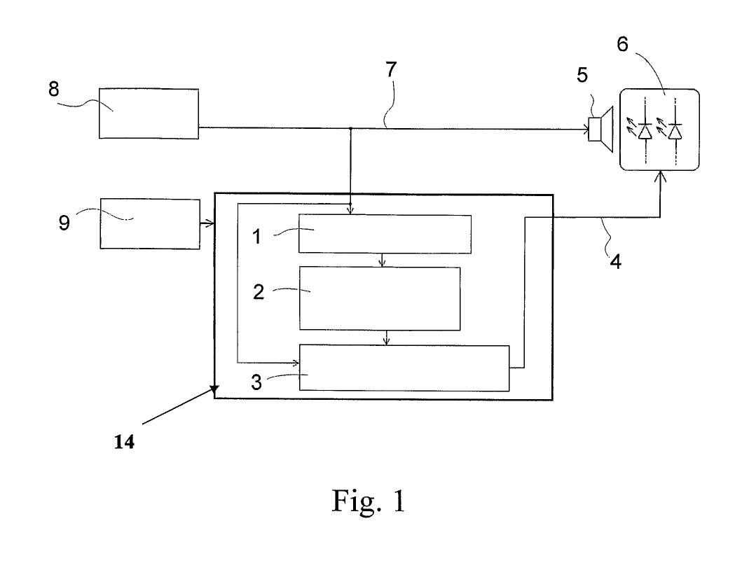

FIG. 1 shows diagram which can create visual stroboscope effect on moving (vibrating) speaker membrane. System uses sound source (8), generated sound signal (7) which is passed to speaker (5). Generated sound signal is also passed to analysator block, which further will be called just “modulator” (14). It has cycle detector, which can detect starting points (1) ultra low frequency generator for virtual oscillations (2) and stroboscope type signal generator and control unit (3). Modulator generates modulated signal (4) which is passed to illumination source (6). It can be LED or other illumination source.

Cycle detector (1) detects starting point by searching for sudden signal amplitude rise points. When these points are found, modulator starts to oscillate using particular method. Low frequency generator (2) gets starting impulse from cycle detector (1) and generates ultra low signal, which is mainly the illumination light frequency, and it's related with effect seen on moving speaker (5) membrane.

Low frequency generator creates ultra low frequency signal, which is passed to stroboscope signal generator and controller block (3) also signal from sound source (8) is passed to this block. Later, signals in block 3 are combined and modulated together. Stroboscope signal generator and controlling unit also creates square wave signals, which are transferred to illumination source. Modulator (14) is powered using external DC source (9).

Illumination source creates light by modulated incoming signal pulse from modulator on speaker (5) moving part (membrane)—movement is related to sound source (7). The difference between real and illuminated movement is created, because the speaker is illuminated only some period impulse light is and only some time moments. Using best realization environment, visual speaker movement frequency will be equal to difference between sound source frequency (5) and illumination source frequency (6):

ƒᵥ=|ƒ_{g}−ƒₛ|;
ƒᵥ—visual speaker moving frequency;
ƒ_{g}—speaker moving frequency;
ƒₛ—stroboscope light impulse frequency.

Sound source (5) moving part visual, possible to see, movement intensity is controlled automatically, but control parameters can be set/changed manually.

Invention effect is used to illuminate low frequency speaker (-ers) with bigger size diameter diaphragm (membrane). Using bigger size speakers, illumination effect is more visible.

Stroboscope control pulse duty cycle makes influence on visual effect quality, for example, while outgoing pulse is shorter, than illumination effect on speaker is better seen. Also, on purpose to reach identical visual illumination, duty cycle can be increased/decreased, according to used frequency at that time.

Using different type of stroboscope control pulse signal combinations, different, anomalous, visual diffuser movement frequencies and motion are visible.

All this effects can be made using different type of modulated signals (4) for different illumination sources (one color or different colors) or different groups of illumination sources (6). Those signals can be different in phase or frequency, then it is possible to see visual illumination effect for the user. Abnormal (visually misshaped) speaker movement is created, user can apprehensible as illuminated dimensional shapes.

Other type of using such an invention is to illuminate speaker whit a projector or projector system, which by the difference of moving speaker frequencies, projects moving or static images on speaker (5) surface. Using projectors tridimensional images can be created on moving speaker membrane. This result is also called hologram. Projector (-rs) can create different moving images, for example, according to music beat, moving hammer, dancing girl or other figures can be shown.

Also it is possible to create mirror layer on speaker membrane and then it is possible to get variable shape projection on near wall or moving object.

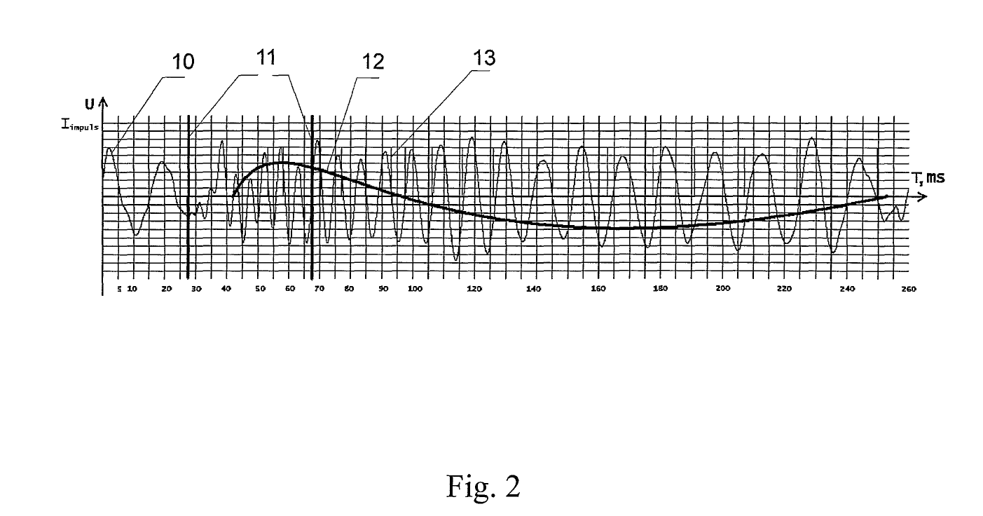

In FIG. 2 is shown 260 ms length sound signal (10). Sound signal is passed through filter—low-pass second order digital filter, which has frequency cut at 250 Hz. By using square wave pulse (13) in different time periods, illumination source (6) visual illumination are formed. During this time light source (6) is emitting rays to speaker membrane (5). Ultra low frequency generator (2) generates low freq. Modulated signal, which from basics are virtual speaker membrane movement visual frequency.

Signal part, which is found between lines (11) is called start of a cycle. Cycle—time between two main similar time repeating metrical accent.

1. (canceled)

2. System according to the claim 10, wherein modulator is designed to accept/receive electrical signal from audio signal source.

3. System according to the claim 10, wherein modulator is designed to accept/receive acoustic signal from speaker signal source.

4. System according to claim 10, wherein light source is mounted in a space near visual moving picture—view.

5. System according to claim 10, wherein at least one light source is placed or mounted near visual moving view and emits light to the visual moving picture direction.

6. System according to claim 10, wherein because at least one of light source is light emitting diode (LED).

7. System according to claim 10, wherein at least one of light source or light system is light projecting device, which is fitted to create projections on audio source moving area and by that creating virtual effect, to be understandable as dimensional (3D) image/video.

8. System according to claim 10, wherein audio source moving area is covered with light reflective material in order to transfer already created visual picture or its part to other static or moving objects.

9. System according to claim 8, wherein reflection passes non fully transparent environment, such as water, liquid gas or air.

10. A system for light effect creation comprising:
an audio signal source;
a sound source which is adopted to create sound based on the audio signal;
at least one light source element; and
a modulator which analyzes the audio signal, and creates a modulated signal to turn on and off the at least one light source to form a visual moving picture, using stroboscope effect.
